(19) United States
(12) Patent Application Publication
(10) Pub. No.: US 2005/0059440 A1
(43) Pub. Date: Mar. 17, 2005

(54) Support base for wireless transmission device

(76) Inventor: Chii Moon Liou, Chong Ho City (TW)

Correspondence Address: Chii Moon Liou, P.O. Box 10-69, Chong Ho, Taipei, 235, TW

(21) Appl. No.: 10/666,605

(22) Filed: Sep. 15, 2003

(51) Int. Cl. H04Q 7/20

(52) U.S. Cl. 455/575.1; 455/90.3

(57) ABSTRACT

A support base includes a housing having an upper opening, a circuit board received in the housing and having a coupler, a cap pivotally secured in the housing and movable to selectively enclose the opening of the housing by such as a spring member. A wireless transmission device includes another coupler engageable into the opening of the housing, and engageable with the coupler of the circuit board, for wireless transmission purposes. The housing includes a channel formed by two tracks and communicating with the opening of the housing, to receive the coupler of the wireless transmission device.

### BACKGROUND OF THE INVENTION

1. Field of the Invention

The present invention relates to a support base for wireless transmission device, and more particularly to a portable or movable support base for changeably supporting various wireless transmission devices.

2. Description of the Prior Art

Typical global satellite systems or global systems for mobile communication are solidly attached to the front portion of vehicles, such as in-built or engaged into the control panels of the vehicles, and coupled to the power supply of the vehicles with electric wires or cables., and may not be adjusted to different directions relative to the vehicles.

In addition, the typical global satellite systems or global systems for mobile communication also may not be changed to the other positions, and may not be disengaged from the vehicles, such that the typical global satellite systems or global systems for mobile communication may not be moved or directed toward the best directions to suitably receive satellite signals when the vehicles are moved to the locations or positions where the reception of the satellite signals is bad.

The present invention has arisen to mitigate and/or obviate the afore-described disadvantages of the conventional supporting problems for the wireless transmission devices.

### SUMMARY OF THE INVENTION

The primary objective of the present invention is to provide a portable or movable support base for changeably supporting various wireless transmission devices.

In accordance with one aspect of the invention, there is provided a support base comprising a housing including an upper portion having an opening formed therein, a circuit board received in the housing, and including a first coupler provided thereon, a cap pivotally secured in the housing, and movable to selectively enclose the opening of the housing, and a wireless transmission device including a second coupler engageable into the opening of the housing, and engageable with the first coupler of the circuit board.

The housing includes a channel formed in the upper portion thereof and communicating with the opening of the housing, to receive the second coupler of the wireless transmission device. The housing includes a pair of tracks provided therein to define the channel, and to receive the second coupler of the wireless transmission device. The housing includes a peripheral flange to define the opening thereof, and the cap includes a peripheral shoulder formed therein to receive the peripheral flange of the housing.

A spring biasing device may further be provided for biasing the cap to enclose the opening of the housing. A bracket may further be provided and attached to bottom of the housing, for securing the housing to vehicles. The housing includes a third coupler provided therein for coupling to the electric power source of the vehicles, for example.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a support base for wireless transmission device in accordance with the present invention;

FIG. 2 is a perspective view of the support base for wireless transmission device;

FIG. 3 is a partial perspective view of the support base for wireless transmission device, as seen from an opposite direction relative to that shown in FIG. 2;

FIG. 4 is a side plan schematic view of the support base for wireless transmission device;

FIG. 5 is a side plan schematic view similar to FIG. 4, illustrating the operation of a spring-biased pivotal cap of the support base for wireless transmission device; and

FIG. 6 is a side plan schematic view similar to FIGS. 4 and 5, illustrating the operation of the support base for wireless transmission device.

### DETAILED DESCRIPTION OF THE PREFERRED EMBODIMENT

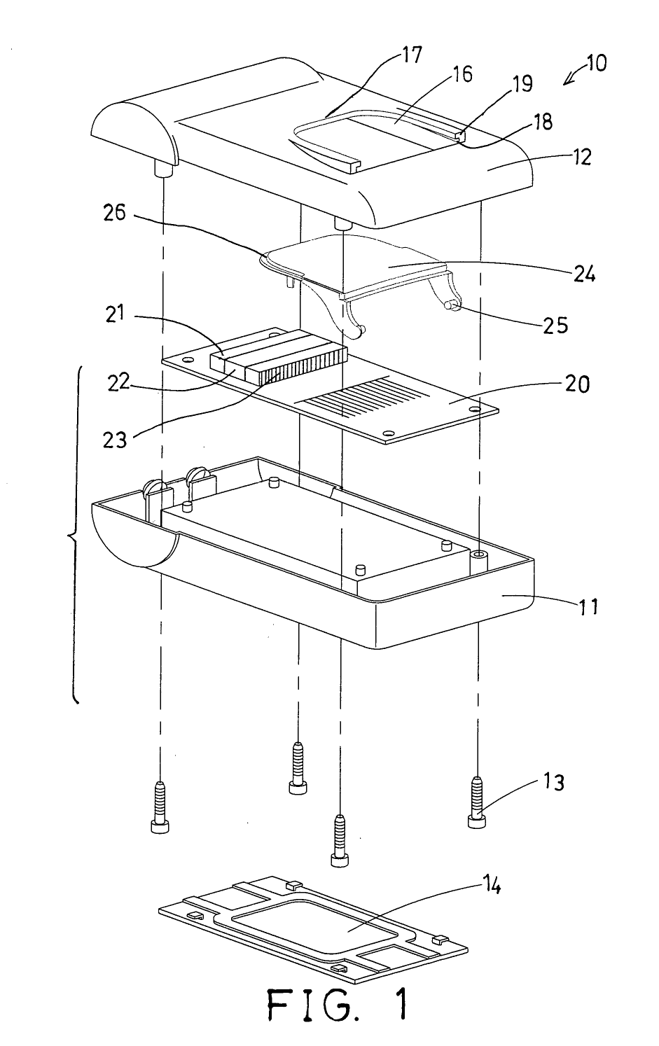

Referring to the drawings, and initially to FIGS. 1-4, a support base for wireless transmission device in accordance with the present invention comprises a housing 10 including a lower casing 11 and an upper cover 12 that may be openably secured together with fasteners 13 or the like.

A bracket 14, such as a metal bracket 14, may be attached to the bottom of the housing 10, for securing to the front portion of vehicles, such as the control panels of the vehicles (not shown), with such as fasteners, magnetically attracting members (not shown), or the like, for detachably securing the housing 10 to the front portion or the control panels of the vehicles.

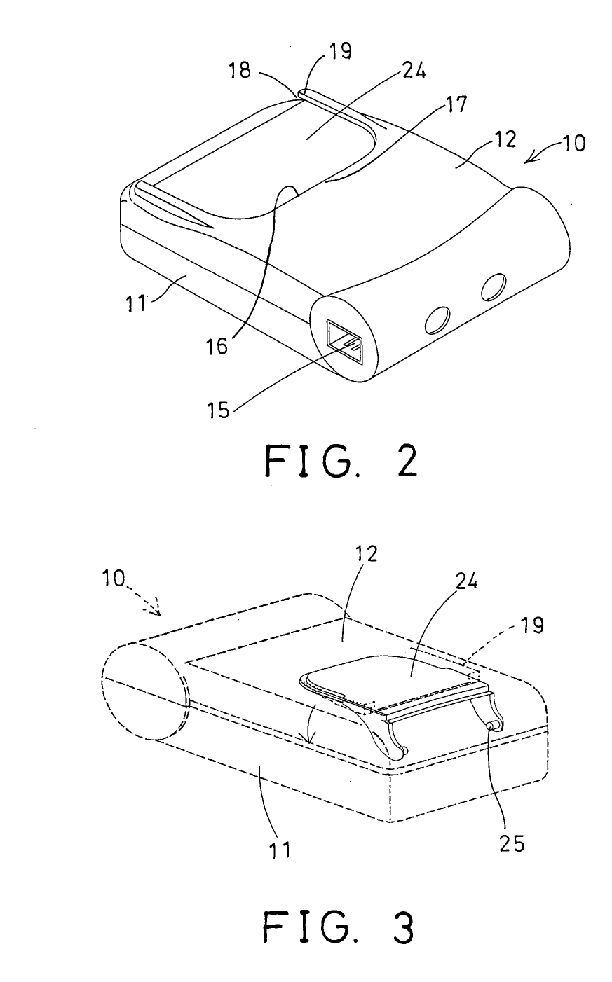

The housing 10 includes a socket or coupler 15 (FIG. 2) formed or provided therein for coupling to the electric power supply of the vehicles, the other electric facilities (not shown), or the like; and includes an opening 16 formed in the upper portion or in the cover 12 thereof, and defined by a peripheral flange 17; and includes a slot or channel 18 formed in the upper portion or in the cover 12 thereof, and defined by a pair of tracks 19.

A circuit board 20 is received in the housing 10, and secured or retained between the lower casing 11 and the upper cover 12, and includes a number of electric elements 21 attached thereto, such as a central processing device 21, a blue tooth transmission device 22, and a coupler 23 attached thereto, and coupled to the central processing device 21, for coupling to the other electric facilities (not shown), or the like.

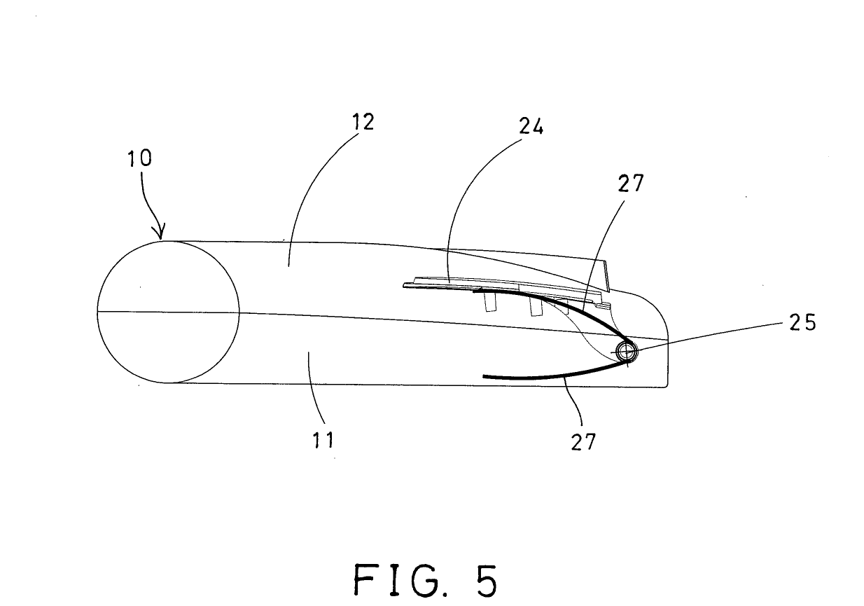

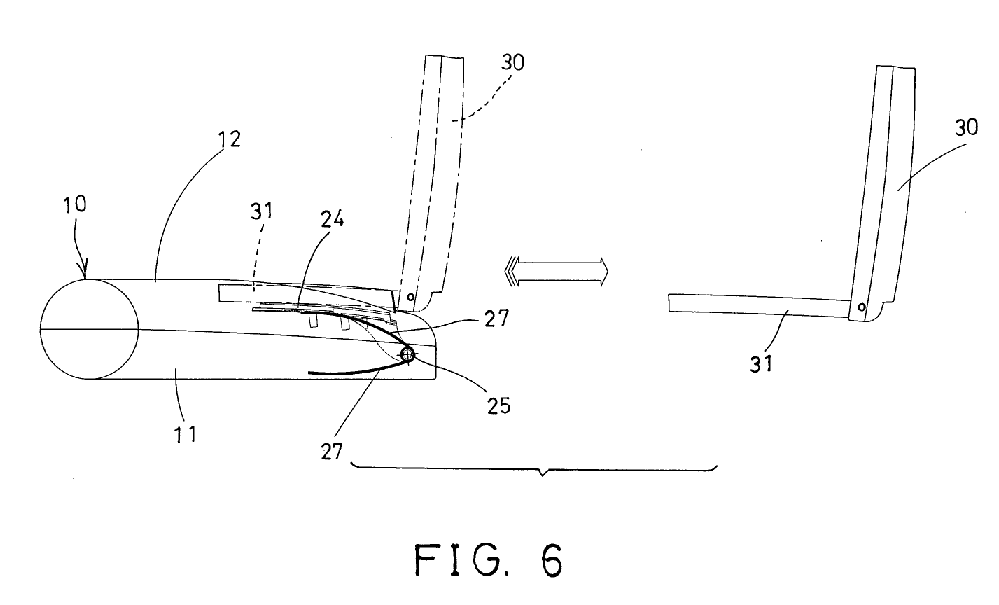

A cap 24 includes one end rotatably or pivotally secured to the housing 10 with one or more pivot axles 25, and arranged within the opening 16 of the housing 10, for opening (FIGS. 5, 6) or enclosing (FIGS. 2-4) the opening 16 of the housing 10, and includes a peripheral shoulder 26 (FIG. 1) formed therein for receiving the peripheral flange 17 of the housing 10, and thus for positioning or anchoring the cap 24 to the housing 10 at the position enclosing the opening 16 of the housing 10.

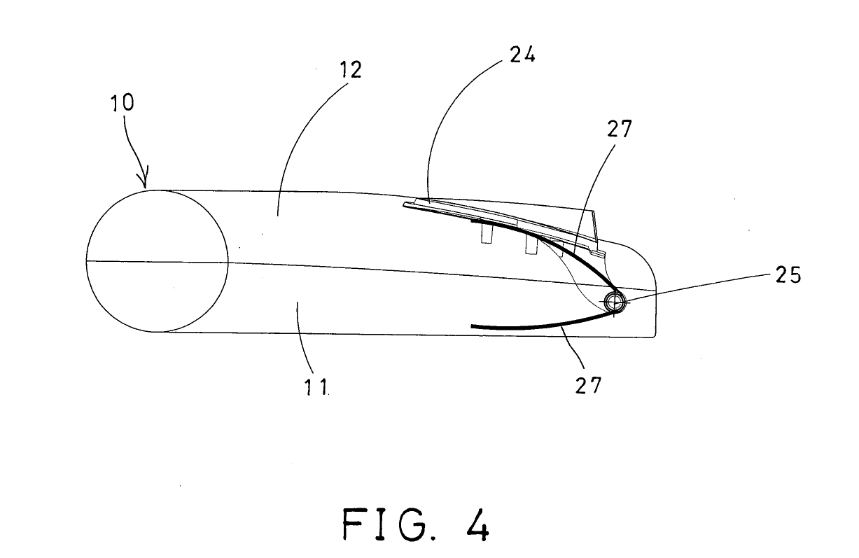

A spring member 27 is disposed in the housing 10, and preferably engaged onto the pivot axles 25 of the cap 24 (FIGS. 4-6), and engaged and biased against the cap 24, to bias and force the cap 24 to openably enclose the opening 16 of the housing 10 (FIGS. 2-4), and to allow the cap 24 to be forced or moved or rotated into the housing 10 against the spring member 27, to open the opening 16 of the housing 10 (FIGS. 5, 6).

In operation, as shown in FIG. 6, various electric facilities 30, such as notebook computers, tablet personal computers, personal digital assistants (PDA), global satellite systems or global systems for mobile communication (GSM), etc. may include a coupler 31 engaged into the channel 18 of the housing 10, and coupled to the coupler 23 of the circuit board 20, for wireless transmission purposes.

It is to be noted that the housing 10 is portable or movable to the other positions or locations of the vehicles, and may be carried with the users, and may be used for changeably supporting various wireless transmission devices 30, and thus for allowing the wireless transmission devices 30 to be operated or used for wireless transmission operations.

Accordingly, the support base for wireless transmission device in accordance with the present invention may be used for changeably supporting various wireless transmission devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A support base comprising:
a housing including an upper portion having an opening formed therein,
a circuit board received in said housing,
a cap pivotally secured in said housing, and movable to selectively enclose said opening of said housing, and
a wireless transmission device including a first coupler engageable into said opening of said housing, and engageable with said circuit board.

2. The support base as claimed in claim 1, wherein said housing includes a channel formed in said upper portion thereof and communicating with said opening of said housing, to receive said first coupler of said wireless transmission device.

3. The support base as claimed in claim 2, wherein said housing includes a pair of tracks provided therein to define said channel, and to receive said first coupler of said wireless transmission device.

4. The support base as claimed in claim 1, wherein said housing includes a peripheral flange to define said opening thereof, and said cap includes a peripheral shoulder formed therein to receive said peripheral flange of said housing.

5. The support base as claimed in claim 1 further comprising means for biasing said cap to enclose said opening of said housing.

6. The support base as claimed in claim 1 further comprising a bracket attached to bottom of said housing, for securing said housing to vehicles.

7. The support base as claimed in claim 1, wherein said circuit board includes a second coupler provided therein, for engaging with said first coupler of said wireless transmission device.

8. The support base as claimed in claim 7, wherein said housing includes a third coupler provided therein.
